(19) United States
(12) Patent Application Publication
(10) Pub. No.: US 2022/0207390 A1
(43) Pub. Date: Jun. 30, 2022

(54) FOCUSED AND GAMIFIED ACTIVE LEARNING FOR MACHINE LEARNING CORPORA DEVELOPMENT

(71) Applicant: Nuxeo Corporation, Brooklyn, NY (US)

(72) Inventors: Tiago Filipe Dias Cardoso, Brooklyn, NY (US); Pedro Miguel Dias Cardoso, Brooklyn, NY (US); Gethin Paul James, Brooklyn, NY (US); Isabel Maria Malheiro de Oliveira Novais Machado, Brooklyn, NY (US); Andrei Nechaev, Brooklyn, NY (US)

(21) Appl. No.: 17/137,663

(22) Filed: Dec. 30, 2020

(51) Int. Cl. G06N 5/04; G06N 20/00

(52) U.S. Cl. CPC G06N 5/04; G06N 20/00

(57) ABSTRACT

The present disclosure describes techniques and systems to provide focused and gamified active learning for machine learning model development. The present disclosure describes determining an active learning algorithm with which to choose batches of content that correspond to specific categories of content to be annotated. Furthermore, the present disclosure provides that the batches of content, and particularly characteristics of the content can be identified for annotation based on ML model performance, such as an entropy of the ML model.

### BACKGROUND

Machine learning (ML) is the study of computer algorithms that improve through experience. Typically, ML algorithms build a model based on sample data, referred to as training data. The model can be used to infer (e.g., make predictions or decisions without explicitly being programmed to do so. As will be appreciated, the quality of the inference a model makes is dependent upon the training data. Thus, there is a need to provide a larger and more complete corpus of knowledge with which these ML models are trained.

### BRIEF SUMMARY

This summary is intended to identify key or essential features of the described subject matter and is not intended to be used in isolation to determine the scope of the described subject matter. The subject matter should be understood by reference to appropriate portions of the entire specification of this patent, any or all drawings, and each claim.

[[This section will be completed with the claims in paragraph form after inventor review of the claims appended at the end of this document]].

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2A illustrates an aspect of the subject matter in accordance with one embodiment.

FIG. 2B illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates a routine 500 in accordance with one embodiment.

FIG. 6 illustrates a computer-readable storage medium 600 in accordance with one embodiment.

FIG. 7 illustrates an aspect of the subject matter in accordance with one embodiment.

### DETAILED DESCRIPTION

Various embodiments are generally directed to creating or adding to a corpora of knowledge for use in training machine learning (ML) models. As will be appreciated, for ML models to evolve positively (e.g., converge upon an acceptable level of inference, or the like) the training data set needs to be large enough and also of sufficient quality. Conventionally, this is a largely manual and time consuming process. For example, content is often manually collated, reviewed, annotated, and eventually selected for use in training ML models. This comes with numerous high costs, not the least of which is the requirement for humans that are experts on the content to manually review batches of content.

Active learning can be used to reduce the amount of content that needs to be reviewed to just that content which enables the ML model to evolve properly. However, even with active learning there are a number of problems related to developing a corpora of knowledge with which to generate training or source training data for ML models.

For example, a substantial amount of manual review is still necessary even accounting for reducing the amount of content to be reviewed when active learning techniques are used. As such, the teams or staff available to review content can be quickly overwhelmed by the scope and amount of work needing to be done to develop ML model training data. Furthermore, reviewing content is often repetitive and tedious. For example, content is typically reviewed via repeating micro-interactions. As such, persons performing the review often loose interest or do not review with the quality needed to correctly develop the corpora.

Another problem with reviewing content based on active learning techniques is that not all content has the same business value. More specifically, in the context of ML models, not all model outputs (e.g., classifications, or the like) have the same business value. For example, some content might be business critical for current processes while other content is representative of the future coming content. As such, it is necessary to prioritize review so that ML models will learn the necessary content in the right order and with better results.

Still another problem with active learning techniques is that human experts are not ranked in terms of their knowledge. As such, it is difficult to match reviewers to the content with which they are qualified to review.

The present disclosure describes techniques and systems to provide focus and gamified active learning for reviewing and annotating content with which to develop or source ML model training data. Said differently, the present disclosure provides systems and techniques for developing a corpora based on content in a content management (CM) system (CMS) or content services platform (CSP) where the development of the corpora can be focused and motivations for development of the corpora gamified. Various embodiments described herein provide a user interface (UI) as well as back end engines arranged to determine an active learning algorithm (e.g., from a number of potential algorithms, or the like) with which to choose batches of content (e.g., from content on the CMS, or the like) that correspond to specific categories of content to be annotated. Additionally, the present disclosure provides that batches of content can be presented more often for annotation (e.g., based on a priority level, or the like). With some examples, the present disclosure can be implemented to select content for annotation based on a priority level, which will makes some batches be presented to users more often.

In some examples, the UI can be generated to include visualization and data comprising indications of the affect the user annotations had on the overall corpora development and/or ML model development. For example, visualization and data can be generated based on a comparison of different versions of ML models (e.g., before the batch annotation and after, or the like). As a specific example, indications of how much more (or less as may be the case) content is automatically added to the corpora by the active learning algorithms based on the user's annotations can be provided.

The present disclosure further provides techniques and systems arranged to flag and/or present content to user's for annotation based on users expertise and/or knowledge as well as motivations for annotating. With some examples, the UI can be generated to include visualization of awards (e.g., badges, expertise level, progress towards advancement, progress towards bonus, comparison with other members of the annotation team, or the like).

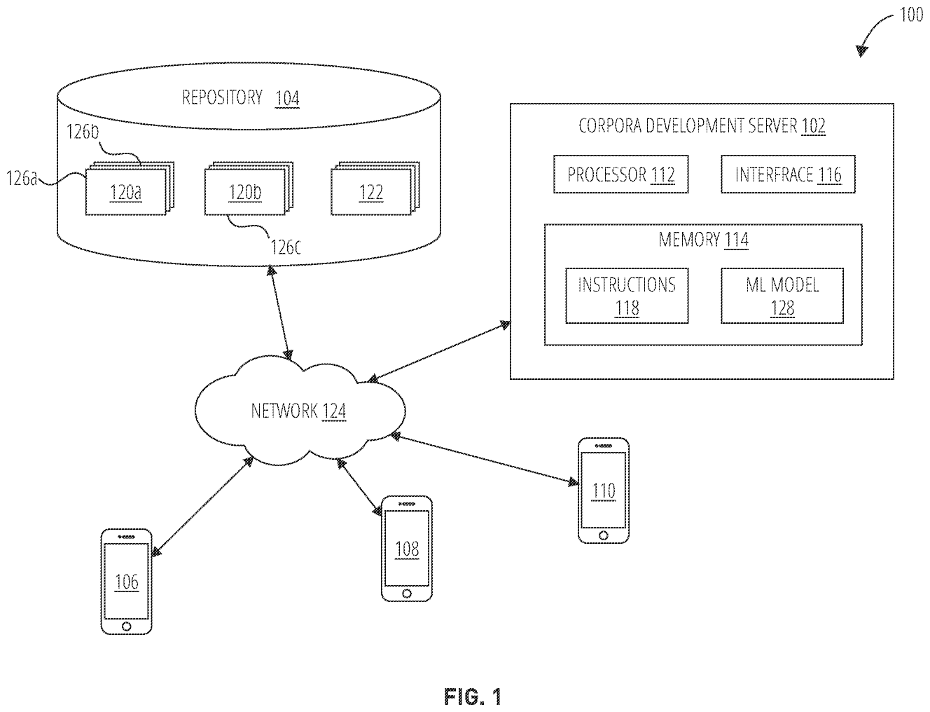

FIG. 1 illustrates a system 100, in accordance with non-limiting example(s) of the present disclosure. System 100 includes corpora development server 102 and repository 104. Additionally depicted are a number of user devices. For example, user device 106, user device 108, and user device 110 are depicted. In general, devices within system 100 are coupled via a network 124, such as, the Internet, a local area network (LAN), a wide area network (WAN), or the like. In general, user devices 106, user device 108, and user device 110 can be any of a variety of devices such as, smart phones, tablets, laptops, desktops, media streaming devices, smart televisions, or the like. Furthermore, although these devices are depicted as having the same format, this is done for convenience only and without limitation. That is, user device 106 can be a smart phone, user device 108 could be a tablet, and user device 110 could be a laptop, or some other combination as can be implemented based on this disclosure. Furthermore, system 100 is not limited to just three (3) user devices as depicted but can instead any number of user devices.

Corpora development server 102 and repository 104 can be implemented as part of a content management system (CMS), a content service platform (CSP), or any service or platform arranged to manage digital content. In general, a CMS manages digital content. A number of types of CMSs are available, such as, for example, a web content management system (WCMS), a digital asset management system (DAMS), a document management system (DMS), enterprise content management (ECM), media asset management (MAM), etc. A CMS typically provides for the creation, modification, management, and/or hosting of various types of “digital content” or digital data. For example, a CMS could provide for management of documents, images, videos, maps, program code, etc. Additionally, for each of the various content types, the CMS can provide format management, versioning, history, indexing, searching, retrieval, etc.

Furthermore, as contemplated in the present disclosure, the CMS can include ML features, for example, use of ML models to automatically recognize, classify, organize, or the like certain content. As a specific example, ML models can be used to automatically classify images managed by the CMS. However, as will be appreciated, the quality of the ML models inference for such tasks is directly dependent upon the quality of the data set used to train the ML model. Furthermore, as the number and types of content managed by the CMS changes, the ML models will need to be re-trained or new ML models will need to be trained. As such, certain portions of the content will need to be annotated to create updated or new data sets with which to train the ML model.

Corpora development server 102 and repository 104 are arranged to provide focused and gamified content to user devices (e.g., user device 106, user device 108, user device 110, or the like) to be annotated to generate a coprora of knowledge with which to train (or rather source training data from) ML models. Corpora development server 102 includes processor 112, memory 114, and one or more auxiliary components, such as, a network interface 116. Memory 114 includes at least instructions 118, which can be executed by processor 112. Instructions 118, when executed by processor 112 cause processor 112 to execute an ML model 128 to infer a classification of a plurality of classifications for one or more content items managed by a CMS, such as, one or more of content 120a, content 120b, or the like.

Processor 112 can execute instructions 118 to identify, based on executing the ML model 128, a plurality of additional content items managed by the CMS (e.g., other ones of content 120a, content 120b, or the like) to be annotated to form a copora with which a data set 122 can be generated to train an ML model (e.g., retrain ML model 128, train other ML models, or the like). With some examples, processor 112 executes instructions 118 to identify characteristics of content items to be annotated. As a specific example, processor 112 can execute ML model 128 over ones of content 120a and/or content 120b (e.g., sample 126a) and identify additional content (e.g., sample 126b and sample 126c) to annotate based on the results of executing ML model 128 over sample 126a.

In some examples, processor 112 can execute instructions 118 to determine an entropy for various inputs and/or outputs of ML model 128 and can determine characteristics of content items to be annotated based on the entropy. That is, inputs and/or outputs with the largest entropy value can be selected for annotation. It is important to note, the present disclosure provides determining to annotate selected characteristics without requiring annotation of all characteristics. As a specific example, where the content items are images of clothes, the characteristics to be annotated can be the type of clothing item, the color of clothing item, the season of clothing item, or the like. In a more specific example, the characteristic to be annotated could be only t-shits. As such, only images depicting t-shits would be marked by the annotators (e.g., user device 106, user device 108, user device 110, etc.)

As another example, processor 112 can execute instructions 118 to determine an unbalance in inputs and/or output. That is, inputs and/or outputs are scored based on their sample size relative to other inputs and/or outputs. As a specific example, where the content items are images of clothes as mentioned above, characteristics of the clothes (e.g., fabric, color, season of use, etc.) can be scored based on how many samples there are relative to the other. For example, if there are more images with fabric samples tagged than season samples tagged, then the fabric samples can receive a higher (or lower as may be the case) score than the season samples. A such, samples with the highest score can be selected for further annotation as detailed here.

Processor 112 can execute instructions 118 to send information elements, to user devices 106, user device 108, and/or user device 110 including indications of the additional content 120a and/or content 120b and the at least one characteristic to be annotated. With some examples, processor 112 can execute instructions 118 to determine an affect of the annotated at least one characteristic of the plurality of additional content items on training of the ML model 128 and provide indications of the affect to the user device.

The user devices (e.g., user device 106, user device 108, user device 110, or the like) can generate a user interface (UI) comprising indications of the affect the annotations will have on development of the ML model 128, badges, expertise level, progress towards advancement, progress towards bonus, comparison with other members of the annotation team, or the like.

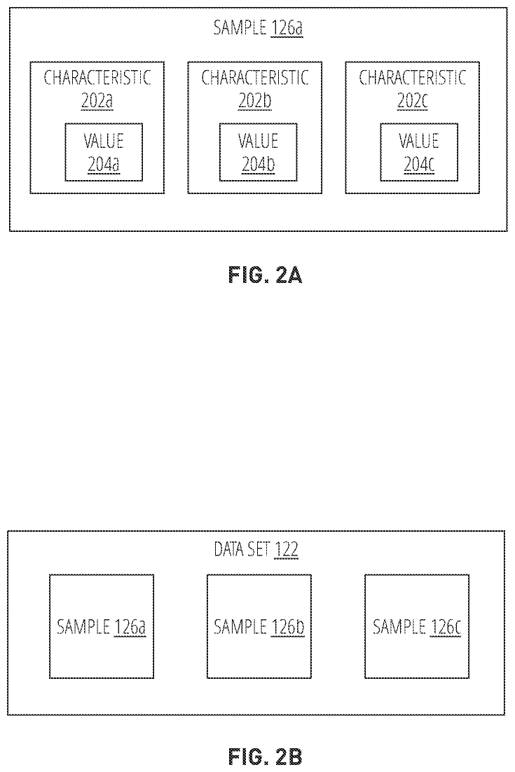

FIG. 2A illustrates exemplary sample 126a according to one or more embodiments described hereby. In the illustrated embodiment, sample 126a includes a number (e.g., one or more) of characteristic 202a, characteristic 202b, and characteristic 202c. Each of characteristic 202a, characteristic 202b, and characteristic 202c includes at least one value. For example, value 204a, value 204b, and value 204c are depicted. Generally, a characteristic may represent a defined feature of a sample, and the feature is defined by the value. As a specific example, reusing the images depicting clothing referenced above, characteristic 202a may include product color and value 204a may include the color (e.g., blue, green, yellow, etc.), characteristic 202b may include product material and value 204b may include the material (e.g., cotton, wool, silk, synthetic, nylon, etc.), and characteristic 202c may include product category and value 204c may include the actual category (e.g., winter clothes, fall 2020 products, or the like). In another examples are possible, such as, characteristics including different cells in a spread sheet, key-value pairs, or the like.

As described herein, the present disclosure is directed towards increasing a corpora of knowledge to improve ML model development. As such, often samples (e.g., sample 126a) in content (e.g., content 120a and content 120b) may not have values filled in. That is, often content is added to a CMS without annotations or tagging and ML model 128 is used to automatically annotate or tag the content. However, the quality with which ML model 128 automatically annotates is based on the training on ML model. As such, as content 120a and content 120b evolve training of ML model 128 must also evolve.

To this end, the present disclosure provides to focus and gamify selection of samples (e.g., sample 126b and sample 126c) with which to annotate as well as select which characteristics (e.g., only characteristic 202c, or the like) to annotate. It is noted that the present disclosure provides an advantage over conventional active learning techniques. For example, the present disclosure provides that selection of samples, characteristics, or samples and characteristics with which to annotate is done based on priorities of the business as well as needs of the ML model. Said differently, the samples and characteristics of samples are selected for annotation based on indications from the ML model. This is explained in greater detail below. Once annotations are done, ML model 128 can be retrained and used to automatically annotate all samples within the content.

That is, once selective annotations are done, a data set 122 can be generated to retrain ML model 128. FIG. 2B illustrates an exemplary data set 122 according to one or more embodiments described hereby. In the illustrated embodiment, data set 122 includes a number of samples (e.g., one or more). In particular, data set 122 includes sample 126a, sample 126b, and sample 126c. In various embodiments, data set 202 may be used to train one or more ML models. It is to be appreciated (although not depicted here) that data set 122 includes both training data and testing data. That is, some samples may be used for training ML model 128 (e.g., based on an ML model training algorithm, an adversarial training algorithm, or the like) while other samples may be used to test the inference quality of the trained ML model 128.

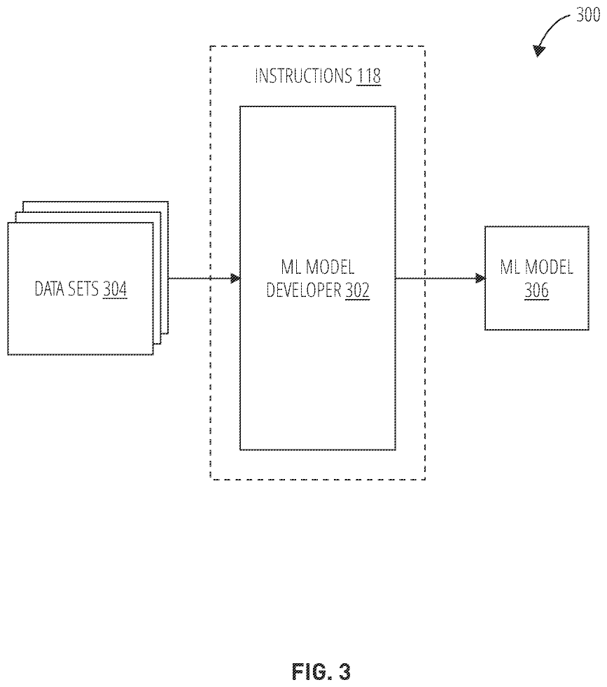

Although the present disclosure is not particularly directed towards actual training methodologies of ML models, an example system is provide here for clarity of presentation and to more fully appreciate the novelty and difficulty of focusing and gamifying annotation of content to generate a corpora with which to train ML models. FIG. 3 illustrates an exemplary operating environment 300 according to one or more embodiments described herein. Operating environment 300 may include ML model developer 302, data sets 304, and ML model 306. Note, that ML model 306 can be ML model 128, can be a retained, or further trained, version of ML model 128, or can be an entirely different ML model. Furthermore, data sets 304 can include data set 122.

In various embodiments, ML model developer 302 may utilize one or more ML model training algorithms (e.g., backpropagation, convolution, adversarial, or the like) to train ML model 306 from data sets 304. Often, training ML model 306 is an iterative process where weights and connections within ML model 306 are adjusted to converge upon a satisfactory level of inference (e.g., output) for ML model 306. In some examples, ML model developer 302 can be incorporated in instructions 118 and executed by a processor (e.g., processor 112, or the like). Furthermore, ML model developer 302 can provide feedback on the training process that can be used to guide selection of characteristics (e.g., characteristic 202a, or the like) and/or samples (e.g., sample 126b, or the like) to be annotated to increase or improve convergence of ML model 306 on a satisfactory solution. For example, ML model developer 302 can provide indications of entropy of ML model 306, inputs of ML model 306, outputs (e.g., particular classes, or the like) of ML model 306. This entropy can be used to select which characteristics and/or samples are to be annotated.

It is to be appreciated that this process of selectively annotating content to improve ML model convergence and/or accuracy is not something that is adaptable to human behavior. For example, humans are not equipped to train ML models, even were they to use pen and paper. That is, modern ML models are simply to complex for humans to derive the mathematical calculations necessary to update weights and connections as part of an ML training algorithm. Furthermore, the present disclosure adds further computational complexity by selecting future or further content annotations based on the ML model performance or ML model inherent characteristics (e.g., entropy). Where this is combined into a CMS, it is simply impossible for a human to sort through, perform calculations for, and organize the amount of information contemplated in the present disclosure.

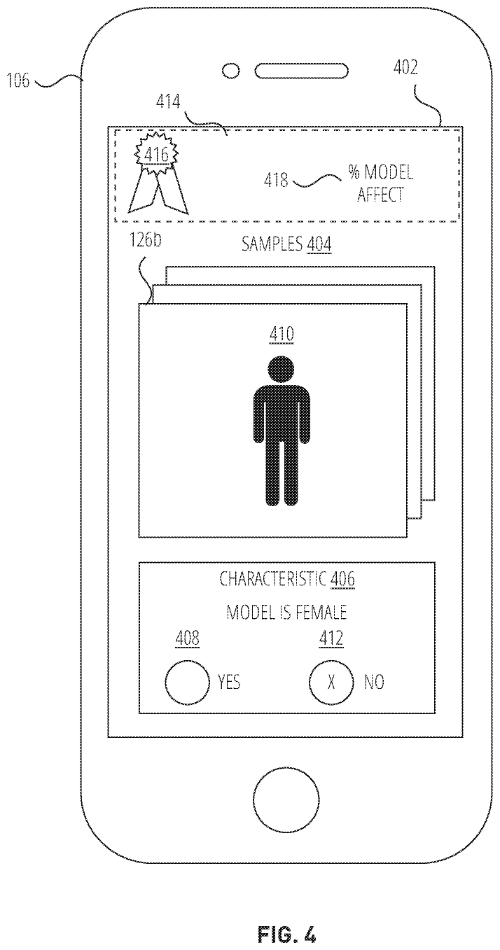

Furthermore, the present disclosure provides to gamify annotating content to motivate annotators. FIG. 4 illustrates a UI 402, in accordance with non-limiting example(s) of the present disclosure. UI 402 can be displayed on a user device, such as, user device 106. UI 402 includes depictions of samples 404 (e.g., samples of content 120a and/or content 120b) such sample 126b to be annotated. The example in FIG. 4 depicts samples 404 as images of models while the characteristic 406 is whether the model is female while the value is yes (e.g., check box 408) or no (e.g., check box 410). For example, characteristic 406 can be determined based on entropy of ML model 128 as detailed herein. As a specific example, if the entropy of output classification female model is the largest of all output classifications then characteristic “is model female” can be selected for further annotation as detailed herein. The characteristic could be phrased differently and could be a text box entry, multiple choice boxes (e.g., male, female, trans, animal, neutral, or the like).

UI 402 can further include UI element 414 comprising indications of awards, badges, expertise level, progress towards advancement, progress towards bonus, comparison with other members of the annotation team, or the like. As a specific example, UI element 414 depicts award 416 related to the user's specific annotation accomplishments. As another example, UI element 414 can include an indication of a predicted affect the annotations will have on ML model 128.

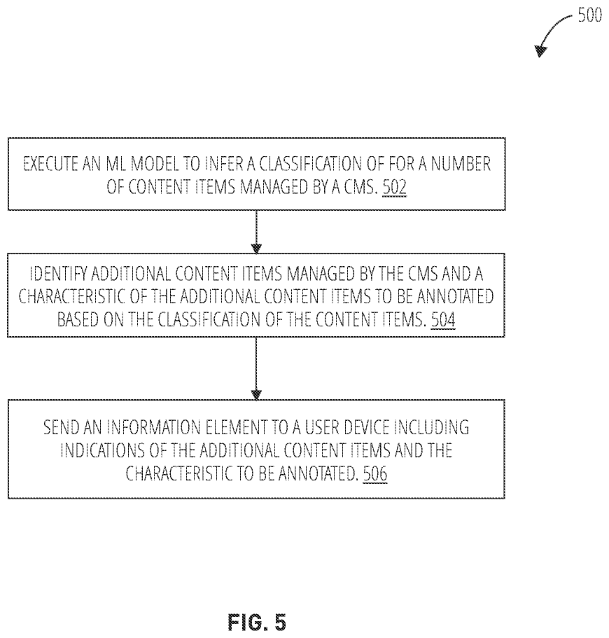

FIG. 5 illustrates a routine 500, in accordance with non-limiting example(s) of the present disclosure. Routine 500 can begin at block 502 At block 502 “execute an ML model to infer a classification of for a number of content items managed by a CMS” processing circuitry can execute an ML model to infer a classification for a number of content items managed by a CMS. For example, processor 112 can execute ML model 128 to infer a classification for ones of content 120a and/or content 120b.

continuing to block 504 “identify additional content items managed by the CMS and a characteristic of the additional content items to be annotated based on the classification of the content items” processing circuitry can identify additional content items to be annotated. In particular, processing circuitry can identify characteristics to annotate based on executing the ML model over a portion of the content. For example, processor 112 can execute instructions 118 to identify characteristic 202a of samples 126b and sample 126c to annotate based on executing ML model over sample 126a.

Continuing to block 506 “send an information element to a user device including indications of the additional content items and the characteristic to be annotated” processing circuitry can send an information element to a user device including indications of the additional content items and the characteristic. For example, processor 112 can execute instructions 118 to send to a user device (e.g., user device 106, or the like) an information element including indications of the additional content (e.g., sample 126b and sample 126c, samples 404, or the like) and the characteristic (e.g., characteristic 202a, characteristic 406, or the like).

As detailed above, the user device can generate a UI to present the content for annotation and to receive annotations of the content. The user device can send to the processing circuitry indications of the completed annotations and the processing circuitry can receive the indications. For example, processor 112 can execute instructions 118 to received from a user device (e.g., user device 106) indications of annotations completed via a UI (e.g., UI 402) presented on the device.

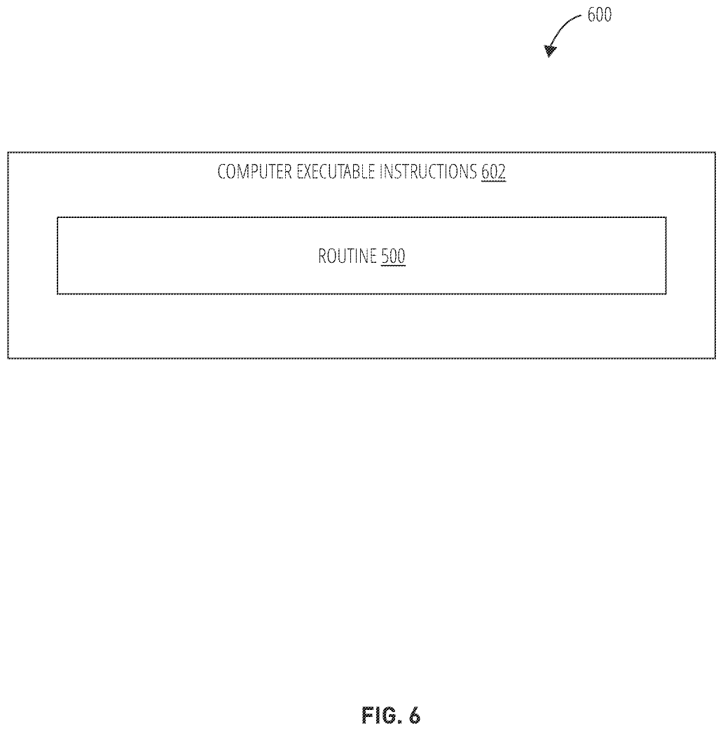

FIG. 6 illustrates computer-readable storage medium 600. Computer-readable storage medium 600 may comprise any non-transitory computer-readable storage medium or machine-readable storage medium, such as an optical, magnetic or semiconductor storage medium. In various embodiments, computer-readable storage medium 600 may comprise an article of manufacture. In some embodiments, 700 may store computer executable instructions 602 with which circuitry (e.g., processor 112, or the like) can execute. For example, computer executable instructions 602 can include instructions to implement operations described with respect to routine 500. Examples of computer-readable storage medium 600 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 602 may include any suitable type of code, such as source code, compiled code, interpreted code, executable code, static code, dynamic code, object-oriented code, visual code, and the like.

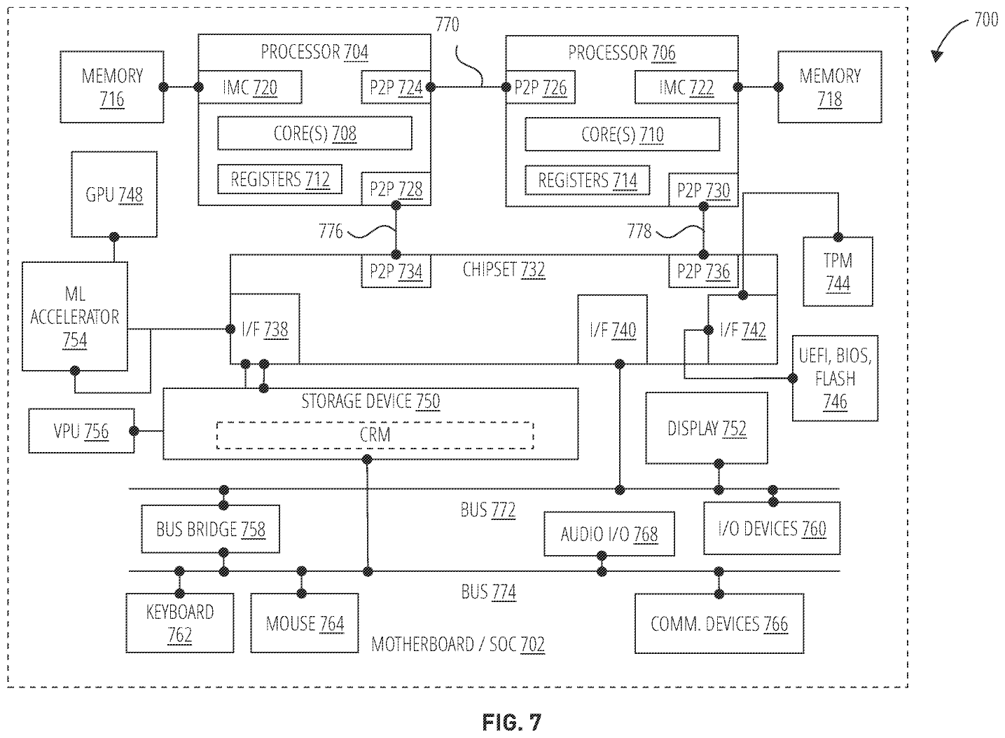

FIG. 7 illustrates an embodiment of a system 700. System 700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 700 may have a single processor with one core or more than one processor. Note that the term “processor” refers to a processor with a single core or a processor package with multiple processor cores. In at least one embodiment, the computing system 700 is representative of the components of the system 100 of FIG. 1, or of a CMS arranged to implement the concepts of the present disclosure. More generally, the computing system 700 is configured to implement all logic, systems, logic flows, methods, apparatuses, and functionality described herein with reference to FIG. 5.

As used in this application, the terms “system” and “component” and “module” are intended to refer to a computer-related entity, either hardware, a combination of hardware and software, software, or software in execution, examples of which are provided by the exemplary system 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 700 comprises a motherboard or system-on-chip (SoC) 702 for mounting platform components. Motherboard or system-on-chip (SoC) 702 is a point-to-point (P2P) interconnect platform that includes a first processor 704 and a second processor 706 coupled via a point-to-point interconnect 770 such as an Ultra Path Interconnect (UPI). In other embodiments, the system 700 may be of another bus architecture, such as a multi-drop bus. Furthermore, each of processor 704 and processor 706 may be processor packages with multiple processor cores including core(s) 708 and core(s) 710, respectively. While the system 700 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processor 704 and chipset 732. Some platforms may include additional components and some platforms may only include sockets to mount the processors and/or the chipset. Furthermore, some platforms may not have sockets (e.g. SoC, or the like).

The processor 704 and processor 706 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi processor architectures may also be employed as the processor 704 and/or processor 706. Additionally, the processor 704 need not be identical to processor 706.

Processor 704 includes an integrated memory controller (IMC) 720 and point-to-point (P2P) interface 724 and P2P interface 728. Similarly, the processor 706 includes an IMC 722 as well as P2P interface 726 and P2P interface 730. IMC 720 and IMC 722 couple the processors processor 704 and processor 706, respectively, to respective memories (e.g., memory 716 and memory 718). Memory 716 and memory 718 may be portions of the main memory (e.g., a dynamic random-access memory (DRAM)) for the platform such as double data rate type 3 (DDR3) or type 4 (DDR4) synchronous DRAM (SDRAM). In the present embodiment, the memories memory 716 and memory 718 locally attach to the respective processors (i.e., processor 704 and processor 706). In other embodiments, the main memory may couple with the processors via a bus and shared memory hub.

System 700 includes chipset 732 coupled to processor 704 and processor 706. Furthermore, chipset 732 can be coupled to storage device 750, for example, via an interface (I/F) 738. The I/F 738 may be, for example, a Peripheral Component Interconnect-enhanced (PCI-e). Storage device 750 can store instructions executable by circuitry of system 700 (e.g., processor 704, processor 706, GPU 748, ML accelerator 754, vision processing unit 756, or the like). For example, storage device 750 can store instructions for instructions 118, routine 500, ML model developer 302, or the like.

Processor 704 couples to a chipset 732 via P2P interface 728 and P2P 734 while processor 706 couples to a chipset 732 via P2P interface 730 and P2P 736. Direct media interface (DMI) 776 and DMI 778 may couple the P2P interface 728 and the P2P 734 and the P2P interface 730 and P2P 736, respectively. DMI 776 and DMI 778 may be a high-speed interconnect that facilitates, e.g., eight Giga Transfers per second (GT/s) such as DMI 3.0. In other embodiments, the processor 704 and processor 706 may interconnect via a bus.

The chipset 732 may comprise a controller hub such as a platform controller hub (PCH). The chipset 732 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 732 may comprise more than one controller hub such as a chipset with a memory controller hub, a graphics controller hub, and an input/output (I/O) controller hub.

In the depicted example, chipset 732 couples with a trusted platform module (TPM) 744 and UEFI, BIOS, FLASH circuitry 746 via I/F 742. The TPM 744 is a dedicated microcontroller designed to secure hardware by integrating cryptographic keys into devices. The UEFI, BIOS, FLASH circuitry 746 may provide pre-boot code.

Furthermore, chipset 732 includes the I/F 738 to couple chipset 732 with a high-performance graphics engine, such as, graphics processing circuitry or a graphics processing unit (GPU) 748. In other embodiments, the system 700 may include a flexible display interface (FDI) (not shown) between the processor 704 and/or the processor 706 and the chipset 732. The FDI interconnects a graphics processor core in one or more of processor 704 and/or processor 706 with the chipset 732.

Additionally, ML accelerator 754 and/or vision processing unit 756 can be coupled to chipset 732 via I/F 738. ML accelerator 754 can be circuitry arranged to execute ML related operations (e.g., training, inference, etc.) for ML models. Likewise, vision processing unit 756 can be circuitry arranged to execute vision processing specific or related operations. In particular, ML accelerator 754 and/or vision processing unit 756 can be arranged to execute mathematical operations and/or operands useful for machine learning, neural network processing, artificial intelligence, vision processing, etc.

Various I/O devices 760 and display 752 couple to the bus 772, along with a bus bridge 758 which couples the bus 772 to a second bus 774 and an I/F 740 that connects the bus 772 with the chipset 732. In one embodiment, the second bus 774 may be a low pin count (LPC) bus. Various devices may couple to the second bus 774 including, for example, a keyboard 762, a mouse 764 and communication devices 766.

Furthermore, an audio I/O 768 may couple to second bus 774. Many of the I/O devices 760 and communication devices 766 may reside on the motherboard or system-on-chip (SoC) 702 while the keyboard 762 and the mouse 764 may be add-on peripherals. In other embodiments, some or all the I/O devices 760 and communication devices 766 are add-on peripherals and do not reside on the motherboard or system-on-chip (SoC) 702.

1. A computer implemented method, comprising:
executing a machine learning (ML) model to infer a classification of a plurality of classifications for a plurality of content items managed by a content management system (CMS);
determining an entropy of the ML model for each of the plurality of classifications;
identifying a plurality of additional content items managed by the CMS to be annotated based on the one of the plurality of classifications with the largest entropy;
identifying at least one characteristic associated with the additional content items, the at least one characteristic a subset of a plurality of possible characteristics associated with the additional content items;
sending a first information element, to a user device, the first information element comprising indications of the plurality of additional content items and the at least one characteristic to be annotated;
receiving, from the user device, an indication of a value of the at least one characteristic for each the plurality of additional content items;
augmenting a corpora of samples with the additional content items and an indication of the value of the at least one characteristic;
generating a training dataset from the corpora of samples; and
retraining the ML model with the training dataset.

2. The computer implemented method of claim 1, wherein the plurality of content items and the additional content items are images and where the at least one characteristic is an item represented in the images.

3. (canceled)

4. The computer implemented method of claim 1, comprising:
sending a second information element to the user device, the second information element comprising indications of information to be included in a user interface comprising instructions to annotate ones of the plurality of additional content items associated with the one of the plurality of classifications with the largest entropy.

5. The computer implemented method of claim 4, comprising:
predicting an affect of the annotated at least one characteristic of the plurality of additional content items on training of the ML model; and
sending a third information element to the user device, the third information element comprising indications of the affect.

6. The computer implemented method of claim 4, comprising:
identifying a plurality of secondary additional content items managed by the CMS to be annotated based on the classification of the plurality of content items; and
sending a fourth information element, to a second user device, the fourth information element comprising indications of the plurality of additional content items and the at least one characteristic to be annotated.

7. A non-transitory computer-readable storage medium, the computer-readable storage medium including instructions that when executed by a computer, cause the computer to:
execute a machine learning (ML) model to infer a classification of a plurality of classifications for a plurality of content items managed by a content management system (CMS);
determine an entropy of the ML model for each of the plurality of classifications;
identify a plurality of additional content items managed by the CMS to be annotated based on the one of the plurality of classifications with the largest entropy;
identify at least one characteristic associated with the additional content items, the at least one characteristic a subset of a plurality of possible characteristics associated with the additional content items;
send a first information element, to a user device, the first information element comprising indications of the plurality of additional content items and the at least one characteristic to be annotated;
receive, from the user device, an indication of a value of the at least one characteristic for each the plurality of additional content items;
augment a corpora of samples with the additional content items and an indication of the value of the at least one characteristic;
generate a training dataset from the corpora of samples; and
retrain the ML model with the training dataset.

8. The computer-readable storage medium of claim 7, wherein the plurality of content items and the additional content items are images and where the at least one characteristic is an item represented in the images.

9. (canceled)

10. The computer-readable storage medium of claim 7, the instructions, when executed by the computer further cause the computer to:
send a second information element to the user device, the second information element comprising indications of information to be included in a user interface comprising instructions to annotate ones of the plurality of additional content items associated with the one of the plurality of classifications with the largest entropy.

11. The computer-readable storage medium of claim 10, the instructions, when executed by the computer further cause the computer to:
predict an affect of the annotated at least one characteristic of the plurality of additional content items on training of the ML model; and
send a third information element to the user device, the third information element comprising indications of the affect.

12. The computer-readable storage medium of claim 10, the instructions, when executed by the computer further cause the computer to:
identify a plurality of secondary additional content items managed by the CMS to be annotated based on the classification of the plurality of content items; and
send a fourth information element, to a second user device, the fourth information element comprising indications of the plurality of additional content items and the at least one characteristic to be annotated.

13. A computing apparatus, comprising:
a content management server, comprising: a processor; and memory storing instructions that, when executed by the processor, cause the apparatus to:
execute a machine learning (ML) model to infer a classification of a plurality of classifications for a plurality of content items managed by a content management system (CMS),
determine an entropy of the ML model for each of the plurality of classifications,
identify a plurality of additional content items managed by the CMS to be annotated based on the one of the plurality of classifications with the largest entropy,
identify at least one characteristic associated with the additional content items, the at least one characteristic a subset of a plurality of possible characteristics associated with the additional content items,
send a first information element, to a user device, the first information element comprising indications of the plurality of additional content items and the at least one characteristic to be annotated,
receive, from the user device, an indication of a value of the at least one characteristic for each the plurality of additional content items,
augment a corpora of samples with the additional content items and an indication of the value of the at least one characteristic,
generate a training dataset from the corpora of samples, and
retrain the ML model with the training dataset; and
a data storage device, storing the plurality of content items and the plurality of additional content.

14. The computing apparatus of claim 13, wherein the one or more content items and the additional content items are images and where the at least one characteristic is an item represented in the images.

15. (canceled)

16. The computing apparatus of claim 13, the instructions, when executed by the processor further cause the apparatus to:
send a second information element to the user device, the second information element comprising indications of information to be included in a user interface comprising instructions to annotate ones of the plurality of additional content items associated with the one of the plurality of classifications with the largest entropy.

17. The computing apparatus of claim 16, the instructions, when executed by the processor further cause the apparatus to:
predict an affect of the annotated at least one characteristic of the plurality of additional content items on training of the ML model; and
send a third information element to the user device, the third information element comprising indications of the affect.

18. The computing apparatus of claim 17, the instructions, when executed by the processor further cause the apparatus to:
identify a plurality of secondary additional content items managed by the CMS to be annotated based on the classification of the one or more content items; and
send a fourth information element, to a second user device, the fourth information element comprising indications of the plurality of additional content items and the at least one characteristic to be annotated.

19. The computing apparatus of claim 18, the instructions, when executed by the processor further cause the apparatus to:
predict an additional affect of the annotated at least one characteristic of the plurality of secondary additional content items on training of the ML model; and
send a fifth information element to the second user device second user device, the fifth information element comprising an indication of the affect contrasted with the additional affect.

20. The computing apparatus of claim 13, the content management server comprising a network interface to couple to a network, wherein the user device is addressable via the network.
